(19) United States
(12) Patent Application Publication
(10) Pub. No.: US 2010/0145971 A1
(43) Pub. Date: Jun. 10, 2010

(54) METHOD AND APPARATUS FOR GENERATING A MULTIMEDIA-BASED QUERY

(75) Inventors: Yan-Ming Cheng, Inverness, IL (US); John Richard Kane, Fox River Grove, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/329,979

(22) Filed: Dec. 8, 2008

(51) Int. Cl. G06F 7/10; G06F 17/30; G06F 7/00

(52) U.S. Cl. 707/759; 707/E17.014

(57) ABSTRACT

A method and apparatus for generating a query from multimedia content is provided herein. During operation a query generator (101) will receive multi-media content and separate the multi-media content into at least a video portion and an audio portion. A query will be generated based on both the video portion and the audio portion. The query may comprise a single query based on both the video and audio portion, or the query may comprise a “bundle” of queries. The bundle of queries contains at least a query for the video portion, and a query for the audio portion of the multimedia event.

### FIELD OF THE INVENTION

The present invention relates generally to generating a query and in particular, to a method and apparatus for generating a multimedia-based query.

### BACKGROUND OF THE INVENTION

Generating search queries is an important activity in daily life for many individuals. For example, many jobs require individuals to mine data from various sources. Additionally, many individuals will provide queries to search engines in order to gain more information on a topic of interest. A problem exists in how to form a query from a multimedia event. Since the multimedia event (e.g., a television program) may contain images, text, voice, . . . , etc., a problem exists in how to form a query in real-time from such an event. Therefore a need exists for a method and apparatus for generating a query from a multimedia event.

### BRIEF DESCRIPTION OF THE DRAWINGS

FIG. 1. is a block diagram of a system for forming a query from a multimedia event.

FIG. 2. is a flow chart showing operation of the system of FIG. 1.

FIG. 3. is a flow chart showing operation of the media specific query generation circuitry of FIG. 1.

FIG. 4 is a flow chart showing operation of the media selection and weighting circuitry of FIG. 1.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. Those skilled in the art will further recognize that references to specific implementation embodiments such as “circuitry” may equally be accomplished via replacement with software instruction executions either on general purpose computing apparatus (e.g., CPU) or specialized processing apparatus (e.g., DSP). It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION OF THE DRAWINGS

In order to address the above-mentioned need, a method and apparatus for generating a query from multimedia content is provided herein. During operation a query generator will receive multi-media content and separate the multi-media content into at least a video portion and an audio portion. A query will be generated based on both the video portion and the audio portion. The query may comprise a single query based on both the video and audio portion, or the query may comprise a “bundle” of queries. The bundle of queries contains at least a query for the video portion, and a query for the audio portion of the multimedia event.

In further embodiments an input from a user may be received and the query generated may be additionally based on the input from the user. For example, the user may ask a question, “tell me more about that country”, and the query will be additionally based upon the user's question. In a similar manner, the user may simply input text, and the query will be additionally based on the user's textual input. In addition to text and voice inputs, gestural inputs from the user and/or biometric inputs (e.g., thumb prints on remote) to identify specific users and/or profiles describing past behaviors and likes/dislikes may be combined with the other user inputs to formulate or extend a query.

Because queries can be generated from multimedia content that utilize both the audio and video, a more relevant query can be produced from a multimedia event.

The present invention encompasses a method for generating a query. The method comprises the steps of receiving multi-media content, separating the multi-media content into at least a video portion and an audio portion, and generating at least one query based on the video portion and the audio portion.

The present invention additionally encompasses a method for generating a query. The method comprises the steps of receiving a video stream and an audio stream, selecting a portion of the video stream and the audio stream for query generation, and creating at least one query to be sent out based on the portion of the video stream and the portion of the audio stream.

The present invention additionally encompasses an apparatus comprising media separation circuitry receiving multimedia content and outputting a video stream and an audio stream, and query generation circuitry receiving the video stream and the audio stream selecting a portion of the video stream and the audio stream and outputting a query based on the portion of the video stream and the portion of the audio stream.

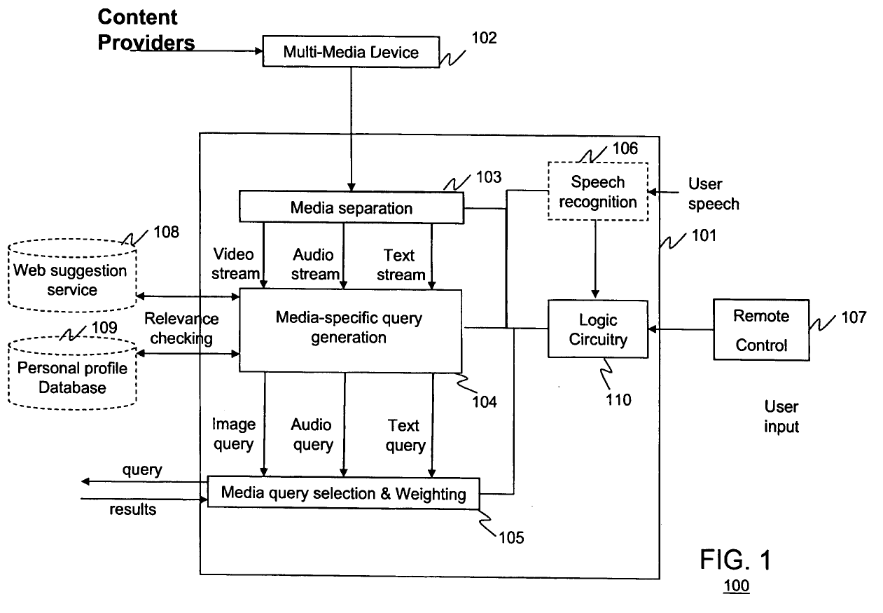

Turning now to the drawings, where like numerals designate like components, FIG. 1 is a block diagram showing system 100 capable of generating a query from multimedia content. As shown, system 100 comprises query generator 101, display 102, user inputs 106 and 107, optional suggestion service 108, and optional database 109.

Display 102 comprises a standard display such as, but not limited to a television, a computer monitor, a handheld display device, . . . , etc. User inputs 106 and 107 comprise any input that allows a user to request a multimedia query. In this particular embodiment, user inputs 106 and 107 comprise a standard television remote 107 and speech recognition circuitry 106. Web suggestion service comprises an external service designed to supply related words or concepts (e.g. Thesaurus-like) based on query inputs. Such web suggestion services are described in, for example, “Google Suggest” (http://www.google.com/support/bin/answer.py?hl=en&answer=106230), which analyzes what a user is typing into the search box and offers relevant suggested search terms in real time. Finally, in this particular embodiment, database 109 comprises a personal profile database 109 storing personal profiles. Database 109 serves to store user interests such as, but not limited to demographic info, viewing history, hobby, fields of interests, etc.

As shown, query generator 101 comprises media separation circuitry 103, media-specific query generation circuitry 104, and query selection and weighting circuitry 105. Optional speech recognition circuitry 106 is provided within generator 101. Finally, query generator 101 comprises logic circuitry 110 used to control the functions of generator 101.

Media separation circuitry 103 serves to separate a multimedia content into a video portion, an audio portion, and a textual portion. The video portion may simply be a small portion of the multimedia video (e.g., 3 seconds), while the audio portion may comprise a portion of the audio from the particular video portion. The textual portion preferably comprises close-captioning text and/or metadata provided with the multimedia content. In one embodiment of the present invention, media separation circuitry is based on decoders/encoders using MPEG elementary streams. An elementary stream (ES) as defined by MPEG communication protocol is usually the output of an audio or video encoder. ES contains only one kind of data, e.g. audio, video or closed captioning.

Query generation circuitry 104 serves to take the individual elemental streams from media separation circuitry 103 and generate specific queries from each stream. For example, query generation circuitry 104 may use a single image from the video stream as an image query. Similarly, query generation circuitry 104 may use a single sentence from the audio stream to form an audio query. Finally, query generation circuitry 104 may use particular key words in a close-captioned television (CCTV) text stream to form a textual query.

In an alternate embodiment, query generation circuitry 104 may utilize suggestion service 108 and personal profiling database 109 in order to form the individual queries. This is accomplished by providing some or all of the individual queries to suggestion service 108. Suggestion service 108 receives the stream(s) and provides circuitry 104 relevant search terms. After relevant search terms are received from service 108, query generation circuitry 104 ranks words/phrases, images and/or sound bites based on web-suggestion services. The words/phrases, images and/or sound bites may be further changed or weighted based on the contents of personal profiling database 109.

In yet a further embodiment of the present invention, query generation circuitry 104 may utilize user inputs when forming the individual queries. This is accomplished by applying, for example, known speech capture and voice recognition technology to capture spoken user commands/questions, such as, “what country was this video filmed in?”, “who is the actor with the gray hair”, . . . . , etc. Alternatively, the user might type the input on a keyboard/keypad, use gestured motions via instrumented sensors in the remote control, etc.

Media query selection and weighting circuitry 105 serves to receive the image query, audio query, and text query from query generation circuitry 104 and form either a single query from the three queries, or form multiple queries and send them out separately to a search engine (not shown). When forming a single query by circuitry 105, a multimedia sequence with metadata is synthesized with respect of the semantic analysis of multimedia and multi-modal inputs. For instance, when watching TV and a user said “what country was this video filmed in?”, a video clip only contains background images and music, which are annotated with country-level geo-tag metadata extracted from the original TV-show or web suggestion services, is synthesized. As another example, when watching TV and a user said “who is the actor with the gray hair”, a video clip, which only contains images and voices of this actor, is generated without any supporting crews.

In case that there exists no multimedia search engine, the circuitry 105 will send out multiple queries: each query for a media. For instance, when watching TV and a user said “what country was this video filmed in?”, a sequence of background pictures is sent to an image search engine, a country-level geo-tag is sent to geo-tag look-up service, and background music is sent to music genre identification service. The returned results from multiple search services are integrated according to a semantic analysis of the input.

During operation of system 100 content providers provide multimedia content to television 102. A person using remote 107 or speech recognition circuitry 106 may inquire about a particular object, image, or text within a multimedia scene. When an inquiry is made, logic circuitry 110 receives the user inquiry from either remote 107 or speech recognition circuitry 106. Logic circuitry 110 then instructs media separation circuitry 103 to separate the video, audio, and text streams from the multimedia content. Logic circuitry 110 also instructs query generation circuitry 104 to generate a query based on the video, voice, and textual streams. As discussed above, this query may comprise a single query, or alternatively may comprise a video, voice, and/or text query. Logic circuitry 110 also instructs query selection and weighting circuitry 105 to generate a query to be sent out to a search engine and to send the query to a search engine. In response, a search engine will provide search results to the user. Search results may simply be provided to television 102 and displayed for a user, may be emailed to the user, may be provided back to selection and weighting circuitry 105, or may be provided to the user as a series of links within a web page on a computer (not shown).

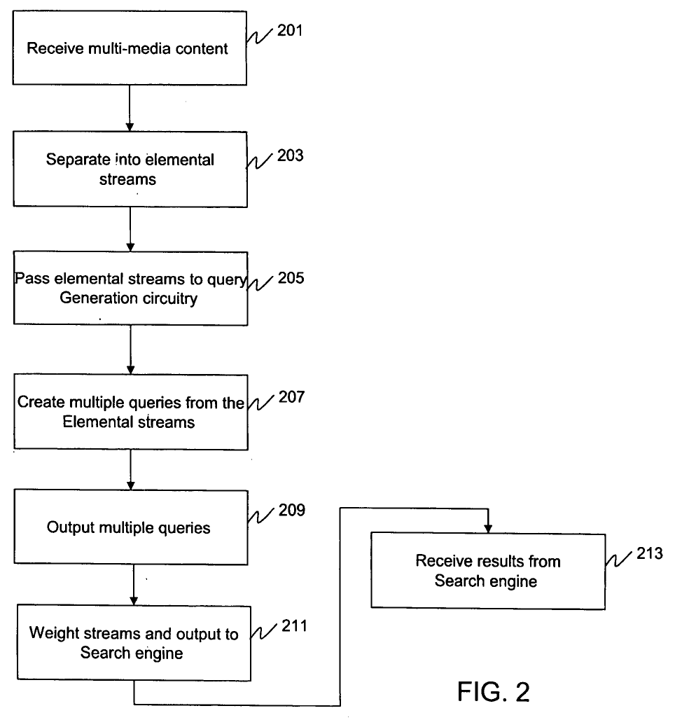

FIG. 2. is a flow chart showing operation of the system of FIG. 1 after receiving a command to generate a query. The logic flow begins at step 201 where multi-media device 102 receives multi-media content from a content provider. At step 203, media separation circuitry 103 receives a portion of the multi-media content and separates the multi-media portion into elemental streams (at least a video portion and an audio portion). The elemental streams are then passed to query generation circuitry 104 (step 205). As discussed above, query generation circuitry 104 creates multiple queries from the elemental streams (step 207).

As discussed above, the query can be optionally based on a suggestion service, a personal profile, and a user input. At step 209 multiple queries are output from query generation circuitry 104. As discussed, there may exist a query for each media type. For example, query generation circuitry 104 may generate at least a video query, an image query comprising an image, an audio query comprising an audio segment, and/or a text query comprising text. The queries enter selection and weighting circuitry 105 where they are weighted and output to a search engine (step 211). Step 211 may comprise the step of generating at least one query. As discussed above, the queries multiple queries received by circuitry 105 may be combined into a single query, or may be sent separately to separate search engines. Finally, at step 213 search results are provided from the search engine. As discussed above, the search results may simply be provided to television 102 and displayed for a user, may be emailed to the user, may be provided back to selection and weighting circuitry 105, or may be provided to the user as a series of links within a web page on a computer (not shown).

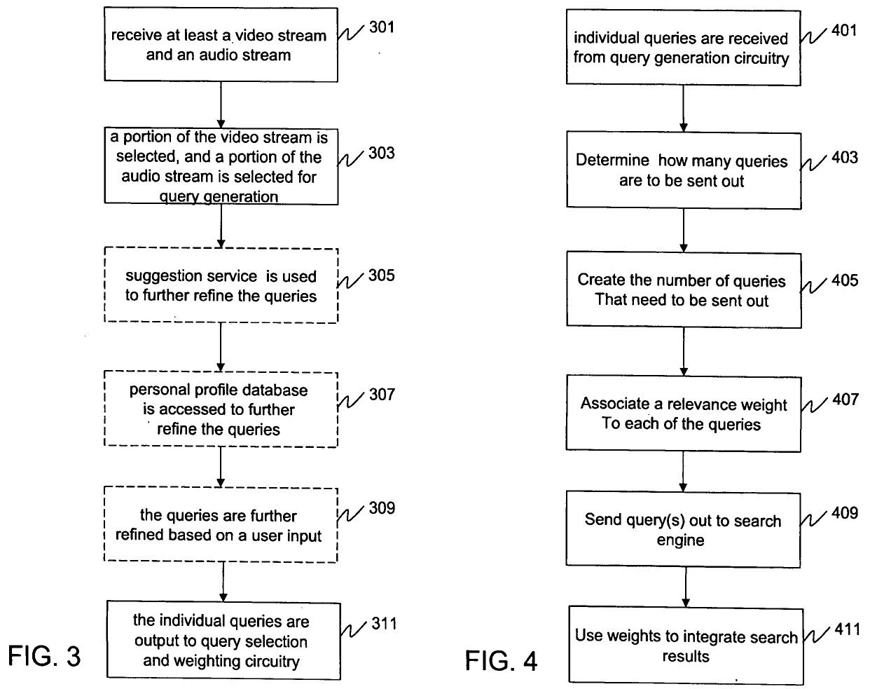

FIG. 3. is a flow chart showing operation of media specific query generation circuitry 104 of FIG. 1 during the generation of a query. The logic flow begins at step 301 where query generation circuitry 104 receives at least a video stream and an audio stream. At step 303 a portion of the video stream is selected, and a portion of the audio stream is selected for query generation and a query is generated by circuitry 104. For example, query generation circuitry 104 may use a single image from the video stream as an image query. Similarly, query generation circuitry 104 may use a single sentence from the audio stream to form an audio query. As discussed above, if a text stream was received query generation circuitry 104 may use particular key words in the CCTV text stream to form a textual query.

At optional step 305 suggestion service 108 is used to further refine any query. This is accomplished by providing some or all of the individual queries to suggestion service 108. Suggestion service 108 receives the stream(s) and provides relevant search terms to circuitry 104. After relevant search terms are received from service 108, query generation circuitry 104 ranks words/phrases, images and/or sound bites based on web-suggestion services. The semantic annotations of the relevant words/phrases, images and/or sound bites may be obtained and personal profiles database 109 may be accessed in order to readjust relevancies of selected key words/phrases, images and/or sound bites by assigning weights or repeating key items accordingly (step 307).

At optional step 307 personal profile database 109 may be accessed to further refine any query generated. At this step query generation circuitry 104 receives a personal profile, which may comprise user interests such as, but not limited to demographic info, viewing history, hobby, fields of interests, etc. This information is further used to refine the query. As an example, assume an individual was interested in topics about astronomy (as indicated in database 109), and assume that an original audio query had the sound /s t A r/ or word “star” in the query. Since the term “star” may be a “movie star”, or an astronomical star, query generation circuitry 104 may stem the word “star” with “sun”, “mars”, etc. as well as corresponding sounds (phonemes). On the contrary, if the user was interested in “movies”, then the term “star” may be stemmed with “movie star”, super star, “star war”, “dance with star”, etc.

At optional step 309 the queries may be further refined based on a received user input. As discussed above, this is accomplished by applying known input technologies such as but not limited to speech capture and voice recognition technology to capture spoken user commands/questions, such as, “what country was this video filmed in”, “who is the actor with the gray hair”, . . . . , etc. (Alternatively, the input may be textual). Thus, specific terms from the input may be further used to modify the queries. As an example, when watching TV and a user said “what country was this video filmed in?”, a video clip only contains background images and music, which are annotated with country-level geo-tag metadata extracted from original TV-show or web suggestion services, is synthesized. As another example, when watching TV and a user said “who is the actor with the gray hair”, a video clip, which only contains images and voices of this actor, is generated without any supporting crews. Finally, at step 311 the individual queries are output to query selection and weighting circuitry 105.

FIG. 4 is a flow chart showing the operation of query selection and weighting circuitry 105. The logic flow begins at step 401 where individual queries are received from query generation circuitry 104. At step 403 a determination is made as to how many queries are to be sent out. For example, if there exists a multi-media search engine capable of receiving images and audio as a whole, then a query consisting of a synthesized multimedia sequence may simply passed to the search engine, however, if a number of search engines, each of which is only capable of searching a single media, such as text, audio, or images, are available, a number of queries has to be created (step 405), each of which is suited to a particular search engine.

A relevance weight associated with each media query is then determined at step 407 and the query(s) are sent out (step 409). These weights are used to integrate any search results received from the multiple search engines into one set of results (step 411). One embodiment of such weight determination and application is described as follows:

Taking the earlier example of watching TV program and saying “tell me more about that country”, based on the semantic analysis the output of speech recognizer, the country-level geo-tag is determined the most important, then the sequence of background images, and finally the background music. The results of geo-tag look-up can be used to augment the image query and/or music query before their searches. The augmented image and music query will lead to more focused (or accurate) search results. In case that there is no clear dominant media query, a soft weight strategy can be taken. For instance, the integrated search results can be the mixture of all results in proportion to weights.

While the invention has been particularly shown and described with reference to a particular embodiment, it will be understood by those skilled in the art that various changes in form and details may be made therein without departing from the spirit and scope of the invention. For example, although three streams were shown exiting from separation circuitry 103 and query generation circuitry 104, fewer or more streams may be utilized. Thus, the above described process may take place utilizing only a video and audio stream exiting from separation circuitry 103. Query generation circuitry 104 will then only generate an image query and an audio query. Additionally, query search results may be received at any element in system 100, or may bypass system 100 altogether. It is intended that such changes come within the scope of the following claims:

1. A method for generating a query, the method comprising the steps of:
receiving multi-media content;
separating the multi-media content into at least a video portion and an audio portion;
generating at least one query based on the video portion and the audio portion.

2. The method of claim 1 wherein the step of generating at least one query comprises the step of generating a video query and an audio query.

3. The method of claim 1 further comprising the steps of:
receiving relevant search terms from a suggestion service;
wherein the step of generating the at least one query is also based on the relevant search terms from the suggestion service.

4. The method of claim 3 wherein the suggestion service provides a service designed to supply related thesaurus-like words or concepts based on query inputs.

5. The method of claim 1 further comprising the steps of:
receiving a personal profile from a personal profile database;
wherein the step of generating the at least one query is also based on the input from the personal profile database.

6. The method of claim 5 wherein the personal profile database comprises a database containing user interests.

7. The method of claim 1 further comprising the steps of:
receiving an input from a user;
wherein the step of generating the at least one query is also based on the input from the user.

8. The method of claim 7 wherein the input from the user is a voice input.

9. The method of claim 1 wherein:
the step of separating the multi-media content into at least a video portion and an audio portion comprises the step of separating the multi-media content into at least a video portion, an audio portion, and a textual portion; and
the step of generating at least one query based on the video portion and the audio portion comprises the step of generating at least one query based on the video portion, the audio portion, and the textual portion.

10. A method for generating a query, the method comprising the steps of:
receiving a video stream and an audio stream;
selecting a portion of the video stream and the audio stream for query generation;
creating at least one query to be sent out based on the portion of the video stream and the portion of the audio stream.

11. The method of claim 10 further comprising the steps of:
receiving an input from a user;
wherein the step of creating the at least one query is also based on the input from the user.

12. The method of claim 11 wherein the input from the user comprises a voice input.

13. The method of claim 10 further comprising the steps of:
receiving relevant search terms from suggestion service;
wherein the step of creating the at least one query is also based on the relevant search terms from the suggestion service.

14. The method of claim 13 wherein the suggestion service provides a service designed to supply related thesaurus-like words or concepts based on query inputs.

15. The method of claim 10 further comprising the steps of:
receiving profile from a personal profile database;
wherein the step of creating the at least one query is also based on the profile from the personal profile database.

16. The method of claim 15 wherein the personal profile database comprises a database containing user interests.

17. The method of claim 10 further comprising the steps of:
receiving a textual stream;
selecting a portion of the textual stream for query generation;
wherein the step of creating the at least one query to be sent out based on the portion of the video stream and the portion of the audio stream comprises the step of creating the at least one query to be sent out based on the portion of the video stream, the portion of the audio stream, and the portion of the textual stream.

18. An apparatus comprising:
media separation circuitry receiving multimedia content and outputting a video stream and an audio stream; and
query generation circuitry receiving the video stream and the audio stream selecting a portion of the video stream and the audio stream and outputting a query based on the portion of the video stream and the portion of the audio stream.

19. The apparatus of claim 18 wherein the query generation circuitry also receives a user input and the query is also based on the user input.

20. The apparatus of claim 18 wherein the query generation circuitry also receives input from a personal profile database and the query is also based on a personal profile.
